(19) United States
(12) Patent Application Publication
(10) Pub. No.: US 2026/0046198 A1
(43) Pub. Date: Feb. 12, 2026

(54) METHOD OF OPTIMIZING ENERGY UTILIZATION IN A SERVICE-BASED ARCHITECTURE (SBA) BASED WIRELESS NETWORK

(71) Applicants: CENTRE OF EXCELLENCE IN WIRELESS TECHNOLOGY, Chennai (IN); INDIAN INSTITUTE OF TECHNOLOGY MADRAS (IIT Madras), Chennai (IN)

(72) Inventors: Ankita Lachhwani, Chennai (IN); Aswathy Subramaniam, Chennai (IN); Anusuya Balasubramanian, Chennai (IN); Jeniston Deviraj Klutto Milleth, Chennai (IN); Bhaskar Ramamurthi, Chennai (IN)

(21) Appl. No.: 19/295,091

(22) Filed: Aug. 8, 2025

(30) Foreign Application Priority Data
Aug. 9, 2024 (IN) 202441060399

(51) Int. Cl. H04L 41/08

(52) U.S. Cl. CPC H04L 41/08

(57) ABSTRACT

The evolution of mobile networks marks a significant leap in communication technologies, driven by the demand for high data rates, ultra-low latency, and enhanced connectivity. A key enabler in 5G is the adoption of Micro Service Based Architecture. Microservice Based Architecture decomposes the complex functionality of 5G Core Network into smaller Network Functions (NFs) that are microservice-based. Microservices provide numerous advantages such as ease of distribution and isolated updates. One of the biggest advantages of microservices is scalability and fault tolerance. But when we look at the future mobile network one alarming concern is sustainability. The energy consumed by these mobile networks is enormous along with that add up the CO2 emissions. An Energy Optimization Controller (EOC) collects energy statistics for the Network per slice/QoS/NF/UE level. It calculates energy efficiency and optimizes by dynamically managing the network.

### CROSS REFERENCE TO RELATED APPLICATIONS

The present application claims priority to and the benefit of Indian Patent Application No. 202441060399, filed on Aug. 9, 2024, the disclosure of which is incorporated herein by reference in its entirety.

### FIELD OF INVENTION

The present invention generally relates to the field of 5G-NR. Particularly, the present invention relates to optimization of energy utilization in a service-based architecture (SBA) based wireless network.

### BACKGROUND OF THE INVENTION

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

The evolution of mobile networks marks a significant leap in communication technologies, driven by the demand for high data rates, ultra-low latency, and enhanced connectivity. A key enabler in 5G is the adoption of Micro Service Based Architecture (SBA). Microservice Based Architecture decomposes the complex functionality of 5G Core Network into smaller Network Functions (NFs) that are microservices-based. Microservices provide numerous advantages such as ease of distribution and isolated updates. One of the biggest advantages of microservices is scalability and fault tolerance.

The 5G technology of mobile networks has brought significant advancement in speed, connectivity, and latencies, laying the groundwork for future sixth generation (6G) communication system.

A pivotal component of 5G is the adoption of service or microservice-based architecture, where the interaction between NFs is defined as microservices. Each NF may support multiple microservices, named as NNF which are loosely coupled which can provide to consumer of the microservice. Microservices enhance network agility by allowing independent development, deployment, and scaling of network functions. This modular approach is essential for dynamically adapting to varying network demands and optimizing resource allocation.

However, the escalating volume of data and the necessary network densification to support it, could exponentially lead to increased energy costs and associated carbon emissions. The energy consumed by these telecommunication networks is enormous along with that they add up the CO₂ emissions.

In 2015, 196 countries adopted the Paris Agreement to reduce global warming and build resilience to climate change with a goal to reduce carbon emission by 45% by 2030 and reach net zero by 2050. The telecom industry plays a pivotal role in energy consumption and the demand for higher data rate and ubiquitous connectivity is increasing energy consumption exponentially. In one of ETSI Report for benchmarking energy consumption mentioned that the Core Network and Data centers accounts for 19% of overall energy consumption of the mobile network. Various KPIs have been defined by Standards Development Organizations (SDOs) for various granularity levels of energy consumption like per QoS flow/PDU session/NF/UE. Though there are smaller energy utilizations in NF, every NF has so many microservices that can remain idle, thus cumulatively adding up to a significant amount of energy consumption.

Thus, there is need in the prior art for providing a method that optimizes energy consumption of an SBA based network to a higher granularity by leveraging micro service-based architecture.

### OBJECT OF THE INVENTION

An object of the present invention is to provide a method of optimizing energy utilization in a service-based architecture (SBA) based wireless network.

Another object of the present invention is to provide a method of optimizing energy utilization in a service-based architecture (SBA) based wireless network in which operating status of a microservice of an NF instance is changed on the basis of its energy consumption, priority and other criteria.

Another object of the present invention is to provide a method of optimizing energy utilization in a service-based architecture (SBA) based wireless network in which a microservice of one NF instance is shifted to another NF instance of same NF type based on energy consumption and other criteria.

### SUMMARY OF THE INVENTION

The summary is provided to introduce aspects related to a method and a node for optimizing energy utilization in a service-based architecture (SBA) based wireless network, and the aspects are further described below in the detailed description. This summary is not intended to identify essential features of the claimed subject matter nor is it intended for use in determining or limiting the scope of the claimed subject matter.

In an aspect, the present disclosure provides a method of optimizing energy utilization in a service-based architecture (SBA) based wireless network, the method comprising receiving, by an energy optimization controller (EOC), a first power consumption information of a network function instance, wherein the first power consumption is the power consumed by the network function instance, determining, by the EOC, if the first power consumption is above a first threshold, obtaining, by the EOC, energy information of plurality of microservices of the network function instance, wherein the energy information comprises information related to power consumed by the plurality of microservices, classifying, by the EOC, each of the plurality of microservices based on the received energy information as one of a high energy utilized microservice, a medium energy utilized microservice and a low energy utilized microservice, retrieving, by the EOC, at least one microservice classified as the low energy utilized microservice, classifying, by the EOC, at least one low energy utilized microservice based on priority level, wherein the priority level is one of: a low priority and a high priority, identifying, by the EOC, at least one low priority microservices, selecting, by the EOC, at least one microservice of interest, informing by the EOC, at least one microservice of interest to the network function instance, changing, by the network function instance, the operating status of the at least one microservice of interest in the network function instances to de-active.

In an aspect, identifying, by the EOC, at least one low priority microservices further comprises of identifying at least one low latency microservices from at least one low priority microservices having latencies below a second threshold.

In an aspect, selecting, by the EOC, at least one microservice of interest, is performed when the second power consumption is greater than the sum of a third power consumption and a fourth power consumption of the at least one low priority microservice wherein, the second power consumption is the power required for the selected microservice when its operating status is idle, the third power consumption is the power required for the selected microservice for changing the operating status to active, the fourth power consumption is the power required for the selected microservice for changing the operating status to de-active.

In an aspect, the second power consumption is a function of time.

In an aspect, the present disclosure provides a method of optimizing energy utilization in a service-based architecture (SBA) based wireless network, the method comprising receiving, by an EOC, power consumed by each of the network function instance of plurality of network function instances, wherein the network function instance comprises plurality of microservices, classifying by the EOC, the plurality of network function instances into at least one first network function instance and at least one second network function instance, wherein the first network function instance comprises at least one network function instance with the power consumed above a threshold and the second network function instance comprises the remaining network function instances, obtaining, by the EOC, energy information comprising information related to power consumed by the plurality of microservices of the at least one first network function instance, selecting, by the EOC, at least one microservice from the plurality of microservices of the at least one first network function instance, based on at least one parameter, determining, by the EOC, the power consumed by the second network function instance, if at least one microservice from the at least one first network function instance is moved to the at least one second network function instance is less than the threshold, shifting the at least one microservice to the at least one second network function instance, until the power consumption of the first network function instance is below the threshold.

In an aspect, the network function instance is of a network function type.

In an aspect, the EOC is one of a network function or a logical entity within a network function.

In an aspect, the method further comprises updating, a network repository function, the plurality of microservice of the plurality of network function instances.

In an aspect, the threshold is at least one of pre-defined in standards or configured by the network or could be shared using any network message.

In an aspect, the at least one parameter comprises energy consumption of at least one of at least one microservice, source of energy, load and other energy characteristics.

In an aspect, the present disclosure provides a node for optimizing energy utilization in a service-based architecture (SBA) based wireless network, wherein the node implements an energy optimization controller (EOC), and is configured to receive, by the EOC, a first power consumption information of a network function instance, wherein the first power consumption is the power consumed by the network function instance, determine, by the EOC, if the first power consumption is above a first threshold, obtain, by the EOC, energy information of plurality of microservices of the network function instance, wherein the energy information comprises information related to power consumed by the plurality of microservices, classify, by the EOC, each of the plurality of microservices based on the received energy information as one of a high energy utilized microservice, a medium energy utilized microservice and a low energy utilized microservice, retrieve, by the EOC, at least one microservice classified as the low energy utilized microservice, classify, by the EOC, at least one low energy utilized microservice based on priority level, wherein the priority level is one of a low priority and a high priority, identify, by the EOC, at least one low priority microservices, select, by the EOC, at least one microservice of interest, inform by the EOC, at least one microservice of interest to the network function instance, change, by the network function instance, the operating status of the at least one microservice of interest in the network function instances to de-active.

In an aspect, the present disclosure provides a node for optimizing energy utilization in a service-based architecture (SBA) based wireless network, wherein the node implements an energy optimization controller (EOC), and is configured to receive, by the EOC power consumed by each of the network function instance of plurality of network function instances, wherein the network function instance comprises plurality of microservices, classify by the EOC, the plurality of network function instances into at least one first network function instance and at least one second network function instance, wherein the first network function instance comprises at least one network function instance with the power consumed above a threshold and the second network function instance comprises the remaining network function instances, obtain, by the EOC, energy information comprising information related to power consumed by the plurality of microservices of the at least one first network function instance, select, by the EOC, at least one microservices from the plurality of microservices of the at least one first network function instance, based on at least one parameter, determine, by the EOC, the power consumed by the second network function instance, when a microservice from the at least one first network function instance is moved to the at least one second network function instance is less than the threshold, shift the at least one microservice to the at least one second network function instance, until the power consumption of the first network function instance is below the threshold.

### BRIEF DESCRIPTION OF ACCOMPANYING DRAWINGS

The accompanying drawings constitute a part of the description and are used to provide a further understanding of the present invention. Such accompanying drawings illustrate the embodiments of the present invention used to describe the principles of the present invention. The embodiments are illustrated by way of example and not by way of limitation in the figures of the accompanying drawings in which references indicate similar elements. It should be noted that references to “an” or “one” embodiment in this invention are not necessarily to the same embodiment, and they mean at least one. In the drawings:

FIG. 1 illustrates a core network that can be represented as a microservice-based architecture which enables other authorized NFs to access their microservices.

FIG. 2 illustrates a microservices related to an exemplary NF instance.

FIG. 3 illustrates microservices-based architecture for AMF instance.

FIG. 4 illustrates a method flow associated with a method of optimizing energy utilization in a service-based architecture (SBA) based wireless network, in accordance with an embodiment of the present invention.

FIG. 5 illustrates a block diagram of operation of a method in accordance with an embodiment of the present invention.

FIG. 6 illustrates a method flow associated with a method of optimizing energy utilization in a service-based architecture (SBA) based wireless network, in accordance with another embodiment of the present invention.

FIG. 7 illustrates a block diagram of operation of a method in accordance with an embodiment of the present invention.

FIG. 8 illustrates a call flow for optimizing energy utilization in a service-based architecture (SBA) based wireless network, in accordance with an embodiment of the present invention.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

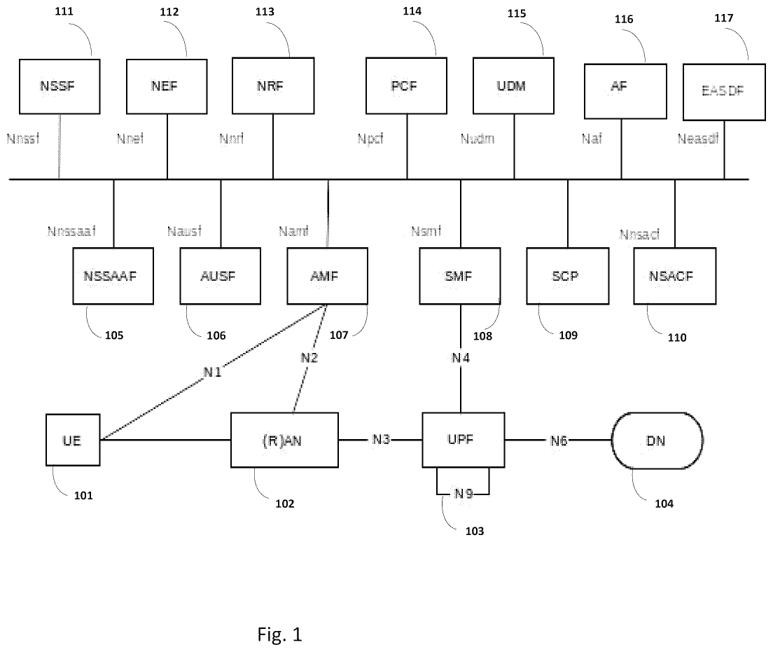

As shown in FIG. 1, core network can be represented as a microservice-based architecture which enables other authorized NFs to access their microservices. For instance, AMF 107 may manage registration, mobility and connection of the UE. The network function PCF 114 implements network policies, access and mobility policies. Similarly, other network functions perform different functions in the core network.

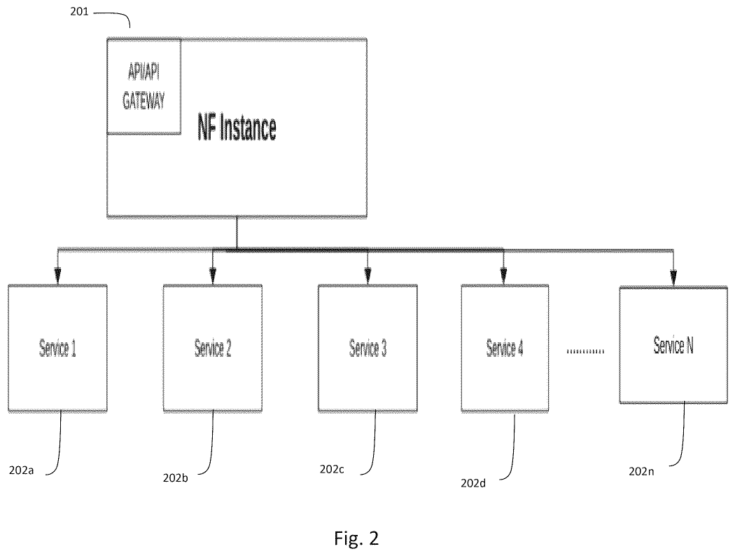

As shown in FIG. 2, a typical NF instance 201 are coupled with microservices 202a to 202n. The NF instance 201 and its microservices can be accessed using API or API gateways.

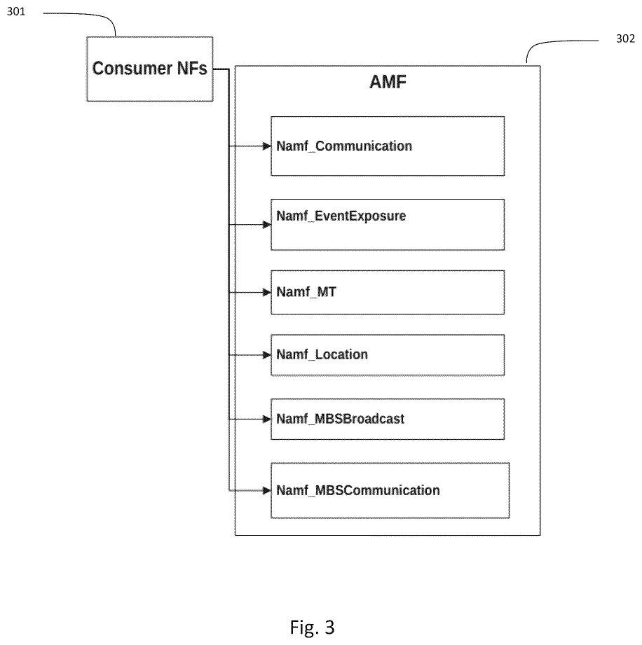

As shown in FIG. 3, a plurality of consumer NFs 301 utilizes services provided by the network function AMF 302.

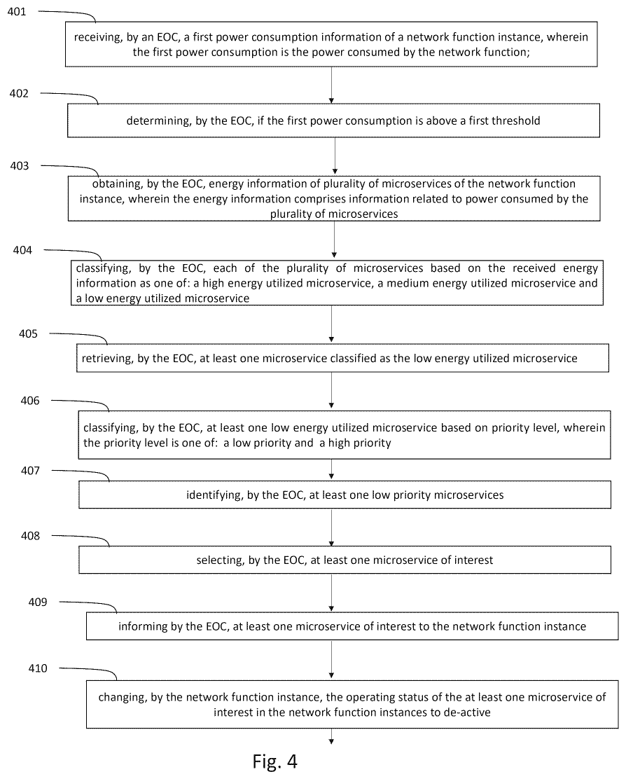

FIG. 4 illustrates a method flow associated with a method of optimizing energy utilization in a service-based architecture (SBA) based wireless network, in accordance with an embodiment of the present invention. As shown in FIG. 4, in the step 401, an Energy Optimization Controller (EOC) receives a first power consumption information of a network function instance. The first power consumption is the power consumed by the network function instance. Thereafter, in the step 402, the EOC determines if the first power consumption is above a first threshold. The first threshold can be at least one of pre-defined in standards or configured by the network or could be shared using any network message

In the step 403, the EOC obtains energy information of plurality of microservices of the network function instance. The energy information contains information related to power consumed by the plurality of microservices.

Based on the energy information in the step 403, the EOC in the step 404, classifies each of the plurality of the microservices as one of a high energy utilized microservice, a medium energy utilized microservice and a low energy utilized microservice. The pre-defined values of energy utilization for each classification may be pre-defined in the EOC.

In the step 405, the EOC retrieves at least one microservice classified as the low energy utilized microservice.

In the step 406, the EOC classifies the low energy utilized microservice as any one of low priority and high priority. This classification may in some embodiments be based on at least one of pre-defined in standards or configured by the network or could be shared using any network message.

In the step 407, the EOC identifies at least one low priority microservices. Thereafter, the EOC in the step 408, selects at least one microservice of interest. The EOC informs the at least one microservice of interest to the network function instance in the step 409.

In some of the embodiments, the step 407 of identifying at least one low priority microservices further comprises of identifying at least one low latency microservices from at least one low priority microservices having latencies below a second threshold. The second threshold may be pre-defined in the EOC.

In some of the embodiments, the step 408 of selecting a microservice of interest is performed by the EOC when the second power consumption is greater than the sum of a third power consumption and a fourth power consumption of the at least one low priority microservice. Here, the second power consumption is the power required for the selected microservice when its operating status is idle. The third power consumption is the power required for the selected microservice for changing the operating status to active. The fourth power consumption is the power required for the selected microservice for changing the operating status to de-active. In some embodiments, the network function instance changes the operating status of at least one microservice of interest in the network function instances to de-active, shown in step 410.

In some of the embodiments, the second power consumption is a function of time.

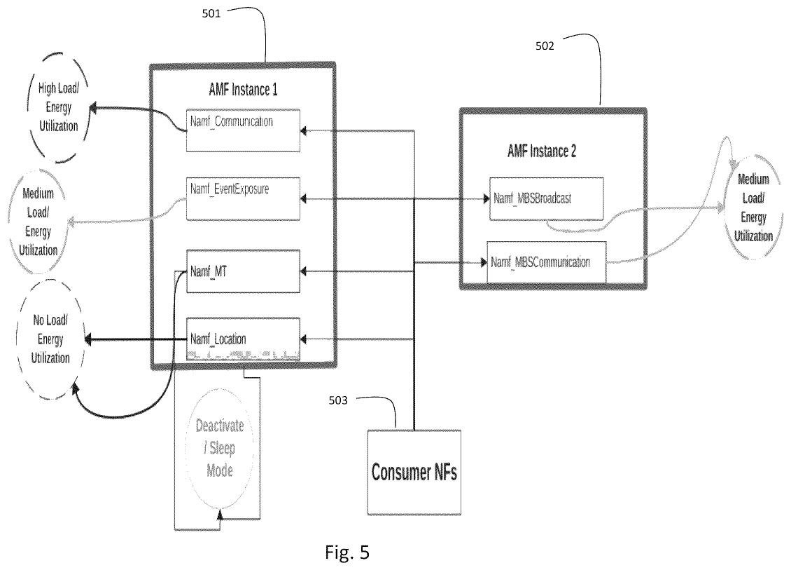

As shown in FIG. 5, the network function instances AMF instance1 501 and AMF instance2, 502 are being utilized by a plurality of Consumer NFs 503 has a plurality of microservices like Namf_Communication etc. In a scenario where the energy consumption of the AMF instance1 501 is above the first threshold, the EOC deactivates the No load/low energy utilization service Namf_Location and changes the status of the service to de-active. Thus, the power consumption of the AMF Instance 1 501 is lowered.

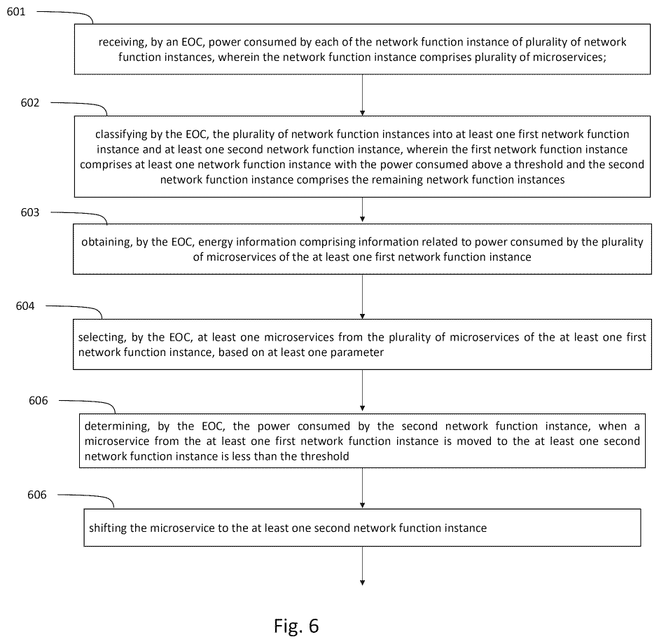

FIG. 6 illustrates a method flow associated with a method of optimizing energy utilization in a service-based architecture (SBA) based wireless network, in accordance with another embodiment of the present invention. In the step 601, an energy optimization controller (EOC) receives power consumed by each of the network function instance of plurality of network function instances. Each of the network function instance comprises a plurality of microservices. In the step 602, the EOC classifies the plurality of network function instances into at least one first network function instance and at least one second network function instance. The first network function instance comprises at least one network function instance with the power consumed above a threshold and the second network function instance comprises the remaining network function instances.

In the step 603, the EOC obtains energy information comprising information related to power consumed by the plurality of microservices of the at least one first network function instance.

In the step 604, the EOC selects at least one microservice from the plurality of microservices of the at least one first network function instance, based on at least one parameter. In the step 605, the EOC determines, the power consumed by the second network function instance, when a microservice from the at least one first network function instance is moved to the at least one second network function instance is less than the threshold.

In the step 606, the at least one microservice is shifted to the at least one second network function instance, until the power consumption of the first network function instance is below the threshold.

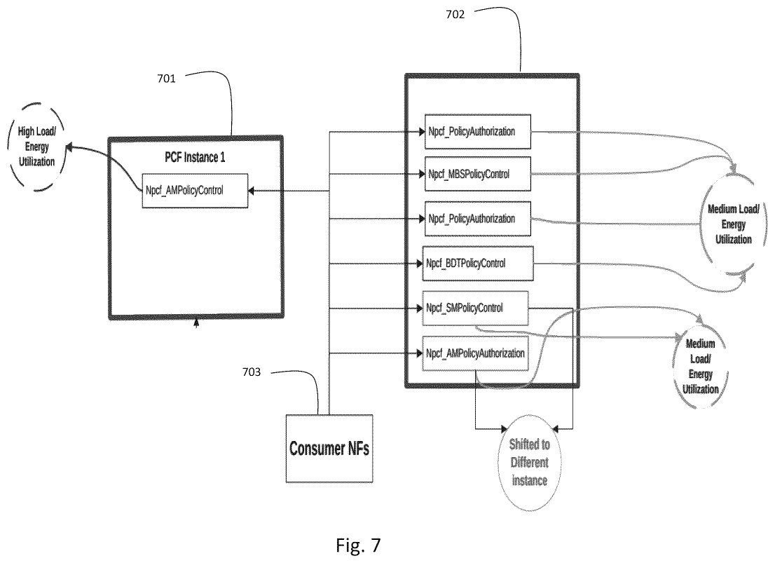

As shown in FIG. 7, Consumer NFs 701 are utilizing network function instances PCF instance1 701 and PCF instance2 702. The EOC receives power consumed by the PCF instance1 701 and the PCF instance2 702. Upon determining that the power consumption of the PCF instance1 701 is above a threshold, the microservices Npcf_SMPolicyControl and Npcf_AMPolicy Authorization are shifted to the PCF instance2 702 after verifying that the power consumption of the PCF instance2 702 is lower than the threshold after the shift of microservices also

In some of the embodiments, the network function instance is of a network function type. The network function type helps in ensuring that when the microservices are shifted, they are shifted to the network function that is of same type as the network function from which the microservice is being shifted.

In some of the embodiments, after each iteration of energy optimization by the methods disclosed in the present disclosures, a network repository function is updated with the plurality of microservices of the plurality of network function instances.

In some of the embodiments, the EOC is one of a network function or a logical entity within a network function.

In some of the embodiments, different kinds of thresholds defined in the present disclosure is at least one of pre-defined in standards or configured by the network or could be shared using any network message.

In some of the embodiments, the at least one parameter comprises energy consumption of at least one of at least one microservice, source of energy, load and other energy characteristics.

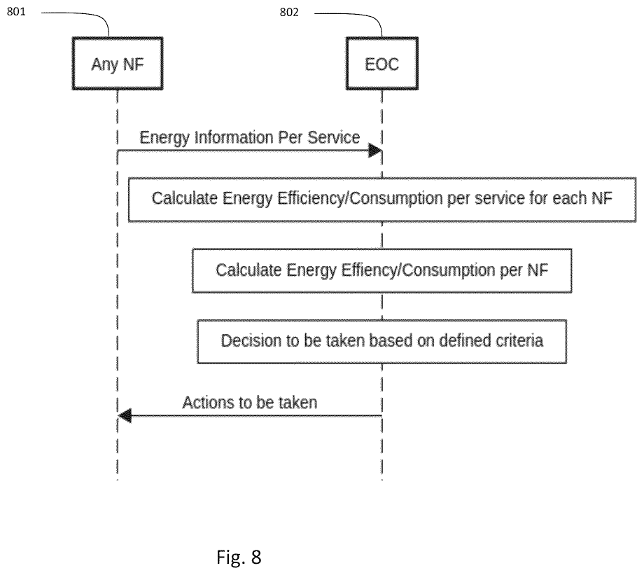

FIG. 8 illustrates a call flow for optimizing energy utilization in a service-based architecture (SBA) based wireless network, in accordance with an embodiment of the present invention. As shown in FIG. 8, any NF instance 801, sends energy information of each microservice to the EOC 802. The EOC 802 calculates energy efficiency/consumption for each microservice for each network function instance. Thereafter the EOC 802 calculates energy efficiency/consumption per network function. As described earlier, if the power consumption of any network function is above a threshold, the EOC 802 takes one or more actions in accordance with the methods of the present disclosure.

In some of the embodiments, the present invention provides a node for optimizing energy utilization in a service-based architecture (SBA) based wireless network, wherein the node implements an energy optimization controller (EOC), and is configured to: receive, by the EOC 802, a first power consumption information of a network function instance, wherein the first power consumption is the power consumed by the network function instance, determine, by the EOC 802, if the first power consumption is above a first threshold, obtain, by the EOC 802, energy information of plurality of microservices of the network function instance, wherein the energy information comprises information related to power consumed by the plurality of microservices, classify, by the EOC 802, each of the plurality of microservices based on the received energy information as one of: a high energy utilized microservice, a medium energy utilized microservice and a low energy utilized microservice, retrieve, by the EOC 802, at least one microservice classified as the low energy utilized microservice, classify, by the EOC 802, at least one low energy utilized microservice based on priority level, wherein the priority level is one of: a low priority and a high priority, identify, by the EOC 802, at least one low priority microservices, select, by the EOC 802, at least one microservice of interest, inform by the EOC 802, at least one microservice of interest to the network function instance, change, by the network function instance, the operating status of the at least one microservice of interest in the network function instances to de-active.

In some of the embodiments, the present invention provides a node for optimizing energy utilization in a service-based architecture (SBA) based wireless network, wherein the node implements an energy optimization controller (EOC), and is configured to: receive, by the EOC 802 power consumed by each of the network function instance of plurality of network function instances, wherein the network function instance comprises plurality of microservices, classify by the EOC 802, the plurality of network function instances into at least one first network function instance and at least one second network function instance, wherein the first network function instance comprises at least one network function instance with the power consumed above a threshold and the second network function instance comprises the remaining network function instances, obtain, by the EOC 802, energy information comprising information related to power consumed by the plurality of microservices of the at least one first network function instance, select, by the EOC 802, at least one microservices from the plurality of microservices of the at least one first network function instance, based on at least one parameter, determine, by the EOC 802, the power consumed by the second network function instance, when a microservice from the at least one first network function instance is moved to the at least one second network function instance is less than the threshold, shift the at least one microservice to the at least one second network function instance.

In some of the embodiments, the EOC 802 is one of a network function or a logical entity within a network function.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1-13. (canceled)

14. A method of optimizing energy utilization in a service-based architecture (SBA) based wireless network, the method comprising:
receiving, by an energy optimization controller (EOC), a first power consumption information of a network function instance, wherein the first power consumption is the power consumed by the network function instance;
determining, by the EOC, if the first power consumption is above a first threshold;
obtaining, by the EOC, energy information of plurality of microservices of the network function instance, wherein the energy information comprises information related to power consumed by the plurality of microservices;
classifying, by the EOC, each of the plurality of microservices based on the received energy information as one of:
a high energy utilized microservice,
a medium energy utilized microservice, and
a low energy utilized microservice;
retrieving, by the EOC, at least one microservice classified as the low energy utilized microservice;
classifying, by the EOC, at least one low energy utilized microservice based on priority level, wherein the priority level is one of:
a low priority, and
a high priority;
identifying, by the EOC, at least one low priority microservices;
selecting, by the EOC, at least one microservice of interest;
informing by the EOC, at least one microservice of interest to the network function instance; and
changing, by the network function instance, an operating status of the at least one microservice of interest in the network function instances to de-active.

15. The method as claimed in claim 14, wherein identifying, by the EOC, at least one low priority microservices further comprises of identifying at least one low latency microservices from at least one low priority microservices having latencies below a second threshold.

16. The method as claimed in claim 14, wherein classifying, by the EOC, each of the plurality of microservices is predefined by an operator.

17. The method as claimed in claim 14, wherein selecting, by the EOC, at least one microservice of interest, is performed when a second power consumption is greater than a sum of a third power consumption and a fourth power consumption of the at least one low priority microservice wherein,
the second power consumption is the power required for the selected microservice when its operating status is idle,
the third power consumption is the power required for the selected microservice for changing the operating status to active, and
the fourth power consumption is the power required for the selected microservice for changing the operating status to de-active.

18. The method as claimed in claim 17, wherein the second power consumption is a function of time.

19. The method as claimed in claim 14,
wherein the EOC is one of a network function or a logical entity within a network function.

20. The method as claimed in claim 14, further comprising:
updating, a network repository function, the plurality of microservices of the plurality of network function instances.

21. The method as claimed in claim 14,
wherein the threshold is at least one of pre-defined in standards or configured by the network or could be shared using any network message.

22. The method as claimed in claim 14,
wherein at least one parameter comprises energy consumption of at least one of at least one microservice, source of energy, load and other energy characteristics.

23. A method of optimizing energy utilization in a service-based architecture (SBA) based wireless network, the method comprising:
receiving, by an energy optimization controller (EOC), power consumed by each of a network function instance of plurality of network function instances, wherein the network function instance comprises plurality of microservices;
classifying by the EOC, the plurality of network function instances into at least one first network function instance and at least one second network function instance, wherein the first network function instance comprises at least one network function instance with the power consumed above a threshold and the second network function instance comprises a remaining network function instances;
obtaining, by the EOC, energy information comprising information related to power consumed by the plurality of microservices of the at least one first network function instance;
selecting, by the EOC, a first at least one microservices from the plurality of microservices of the at least one first network function instance, based on at least one parameter;
determining, by the EOC, a second at least one microservice from the first at least one microservice, such that the power consumed by the first network function and the second network function instance is less than a threshold assuming at least one microservice from that first at least one micro service is shifted to the second network function instance; and
shifting the second at least one microservice to the at least one second network function instance.

24. The method as claimed in claim 23,
wherein the network function instance is of a network function type.

25. The method as claimed in claim 23,
wherein the EOC is one of a network function or a logical entity within a network function.

26. The method as claimed in claim 23, further comprising:
updating, a network repository function, the plurality of microservices of the plurality of network function instances.

27. The method as claimed in claim 23,
wherein the threshold is at least one of pre-defined in standards or configured by the network or could be shared using any network message.

28. The method as claimed in claim 23,
wherein at least one parameter comprises energy consumption of at least one of at least one microservice, source of energy, load and other energy characteristics.

29. A node for optimizing energy utilization in a service-based architecture (SBA) based wireless network, wherein the node implements an energy optimization controller (EOC), and is configured to:
receive, by the EOC, a first power consumption information of a network function instance, wherein the first power consumption is the power consumed by the network function instance;
determine, by the EOC, if the first power consumption is above a first threshold;
obtain, by the EOC, energy information of plurality of microservices of the network function instance, wherein the energy information comprises information related to power consumed by the plurality of microservices;
classify, by the EOC, each of the plurality of microservices based on the received energy information as one of:
a high energy utilized microservice,
a medium energy utilized microservice, and
a low energy utilized microservice;
retrieve, by the EOC, at least one microservice classified as the low energy utilized microservice;
classify, by the EOC, at least one low energy utilized microservice based on priority level, wherein the priority level is one of:
a low priority, and
a high priority;
identify, by the EOC, at least one low priority microservices;
select, by the EOC, at least one microservice of interest;
inform by the EOC, at least one microservice of interest to the network function instance; and
change, by the network function instance, an operating status of the at least one microservice of interest in the network function instances to de-active.

30. The node as claimed in claim 29,
wherein the EOC is one of a network function or a logical entity within a network function.

31. A node for optimizing energy utilization in a service-based architecture (SBA) based wireless network, wherein the node implements an energy optimization controller (EOC), and is configured to:
receive, by the EOC, power consumed by each of a network function instance of plurality of network function instances, wherein the network function instance comprises plurality of microservices;
classify by the EOC, the plurality of network function instances into at least one first network function instance and at least one second network function instance, wherein the first network function instance comprises at least one network function instance with the power consumed above a threshold and the second network function instance comprises a remaining network function instances;
obtain, by the EOC, energy information comprising information related to power consumed by the plurality of microservices of the at least one first network function instance;
select, by the EOC, a first at least one microservices from the plurality of microservices of the at least one first network function instance, based on at least one parameter;
determine, by the EOC, a second at least one microservice from the first at least one microservice, such that the power consumed by the first network function and the second network function instance is less than a threshold assuming at least one microservice from that first at least one micro service is shifted to the second network function instance; and
shift the second at least one microservice to the at least one second network function instance.

32. The node as claimed in claim 31,
wherein the EOC is one of a network function or a logical entity within a network function.
